(19) United States
(12) Patent Application Publication
(10) Pub. No.: US 2014/0153236 A1
(43) Pub. Date: Jun. 5, 2014

(54) LIGHT EMITTING DIODE BULB

(71) Applicant: ADVANCED OPTOELECTRONIC TECHNOLOGY, INC., Hsinchu Hsien (TW)

(72) Inventors: Lung-Hsin CHEN, Hukou (TW); Pin-Chuan CHEN, Hukou (TW); Wen-Liang TSENG, Hukou (TW)

(73) Assignee: ADVANCED OPTOELECTRONIC TECHNOLOGY, INC., Hsinchu Hsien (TW)

(21) Appl. No.: 13/966,243

(22) Filed: Aug. 13, 2013

(30) Foreign Application Priority Data
Dec. 4, 2012 (CN) 2012105121287

(51) Int. Cl. F21K 99/00

(52) U.S. Cl. CPC F21K 9/1355
USPC 362/235; 362/249.02

(57) ABSTRACT

A light emitting diode (LED) bulb includes a connecting body having a first end and a second end opposite to the first end, a mounting base located at a second end of the connecting body and a plurality of LED units mounted on the mounting base. The mounting base has a top face distant from the second end of the connecting body and an inclined lateral face located between the top face of the mounting base and the second end of the connecting body. The inclined lateral face of the mounting base extends downwardly and inwardly from a periphery of the top face of the mounting base towards the second end of the connecting body. The plurality of LED units mounted on the first top face and the inclined lateral face of the mounting base, respectively.

### TECHNICAL FIELD

The present disclosure relates generally to illumination devices, and more particularly to a light emitting diode (LED) bulb having an improved light distribution.

### DESCRIPTION OF RELATED ART

LEDs are solid state light emitting devices formed of semiconductors, which are more stable and reliable than other conventional light sources such as incandescent bulbs. Thus, LEDs are being widely used in various fields such as numeral/character displaying elements, signal lights, light sources for lighting and display devices.

A traditional LED bulb includes a holder, a substrate located at one end of the holder, a plurality of LED modules arranged on a flat plane of the substrate and a lampshade enclosing the substrate and the LED modules therein. However, a light emitting angle of the traditional LED bulb is less than 120 degrees and a light distribution of the traditional LED bulb is mostly concentrated at a center axis while becomes gradually weaker towards a periphery. Therefore, such an LED bulb is difficult to satisfy the requirements of uniform light distribution.

What is needed therefore is an LED bulb which can overcome the above mentioned limitations.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic, cross sectional view of an LED (light emitting diode) bulb in accordance with a first embodiment of the present disclosure.

FIG. 2 is a perspective view of a mounting base of the LED bulb of FIG. 1, with three LED units mounted thereon.

FIG. 3 is another perspective view of the mounting base of the LED bulb of FIG. 1, with two LED units mounted thereon.

FIG. 4 is a schematic, cross sectional view of an LED (light emitting diode) bulb in accordance with a second embodiment of the present disclosure.

### DETAILED DESCRIPTION

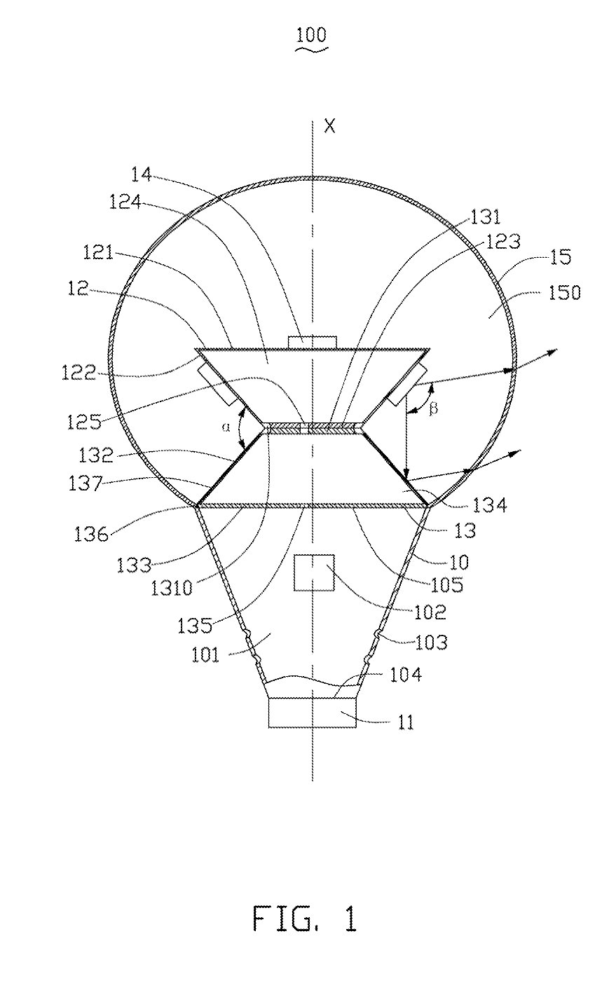

Referring to FIGS. 1, 2 and 3, a light emitting diode (LED) bulb 100 in accordance with a first embodiment of the present disclosure includes a connecting body 10 having a first end 104 and a second end 105 opposite to the first end 104, a lamp cap 11 located at the first end 104 of the connecting body 10, a supporting base 13 located at the second end 105 of the connecting body 10 opposite to the first end 104, a mounting base 12 spaced from the connecting body 10 and placed on a top end 131 of the supporting base 13, and a plurality of LED units 14 mounted on the mounting base 12.

The supporting base 13 is located between the mounting base 12 and the connecting body 10. The supporting base 13 interconnects the mounting base 12 and the second end 105 of the connecting body 10. The supporting base 13 has an inclined lateral face 132 extending upwardly and inwardly from a periphery of the second end 105 of the connecting body 10 towards a bottom end 123 of the mounting base 12.

The mounting base 12 interconnects end-to-end with the supporting base 13. The bottom end 123 of the mounting base 12 has a same size as that of the top end 131 of the supporting base 13. The mounting base 12 has a top face 121 and an inclined lateral face 122. The inclined lateral face 122 of the mounting base 12 is located between the top face 121 of the mounting base 12 and the second end 105 of the connecting body 10. The inclined lateral face 122 of the mounting base 12 extends downwardly and inwardly from a periphery of the top face 121 of the mounting base 12 towards the top end 131 of the supporting base 13.

The top face 121 of the mounting base 12 orients a direction different from that of the inclined lateral face 122 of the mounting base 12. In the present embodiment, the top face 121 of the mounting base 12 is parallel to the second end 105 of the connecting body 10. The plurality of LED units 14 are arranged on the top face 121 and the inclined lateral face 122 of the mounting base 12, respectively.

The connecting body 10 is a hollow tube and defines a passage 101 communicating with the two opposite ends, i.e., the first end 104 and the second end 105. The first end 104 of the connecting body 10 is an open end and sealed by the lamp cap 11. The second end 105 of the connecting body 10 is sealed by the supporting base 13. In the present embodiment, the second end 105 of the connecting body 10 has a size larger than that of the first end 104 of the connecting body 10. The passage 101 has a diameter gradually increasing from the first end 104 to the second end 105.

The LED bulb 100 further includes a driving circuit module 102 received in the passage 101 of the connecting body 10. The driving circuit module 102 is electrically connected to the plurality of LED units 14 and supplies the electrical power to the LED units 14.

The mounting base 12 has a first inner cavity 124 formed therein. The supporting base 13 has a second inner cavity 134 communicating the first inner cavity 124 of the mounting base 12 with the passage 101 of the connecting body 10. The LED bulb 100 further defines a first through hole 125 and a second through hole 135. The first through hole 125 extends through the bottom end 123 of the mounting base 12 and the top end 131 of the supporting base 13 to communicate the first inner cavity 124 of the mounting base 12 with the second inner cavity 134 of the supporting base 13. The second through hole 135 extends through the bottom end 133 of the supporting base 13 to communicate the second inner cavity 134 of the supporting base 13 with the passage 101 of the connecting body 10.

The LED bulb 100 further includes a lampshade 15 connected to the supporting base 13. The bottom end 133 of the supporting base 13 defines an annular groove 136 near a joint of the supporting base 13 and the connecting body 10. The lampshade 10 is fixed in the groove 136 of the supporting base 13. The lampshade 10 defines an enclosed space 150 for receiving the supporting base 13 and the mounting base 12 therein.

A low portion of the connecting body 10 defines a plurality of air outlets 103. The plurality of air outlets 103 extend through a lateral wall of the connecting body 10 to communicate the passage 101 of the connecting body 10 with the outside. The plurality of air outlets 103 are positioned in a circle around a vertical central axis X of the connecting body 10. In this embodiment, the air outlets 103 are located on two spaced and parallel circles with centers in the vertical central axis X.

A plurality of air inlets 1310 are defined near a joint of the mounting base 12 and the supporting base 13. The plurality of air inlets 1310 are communicating with the first inner cavity 124 of the mounting base 12 and the second inner cavity 134 of the supporting base 13.

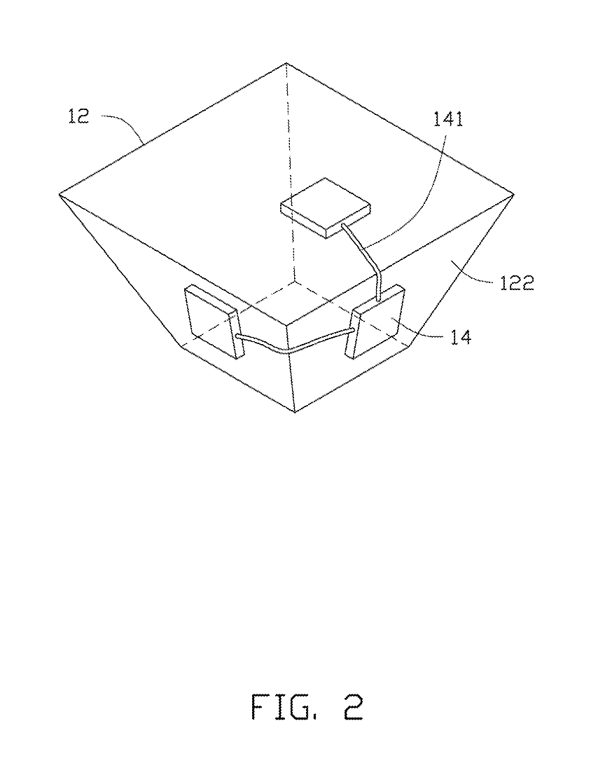

The mounting base 12 is truncated-pyramid or truncated-cone shaped. Two adjacent LED units 14 are connected with each other in series or parallel via electrical wires 141. The mounting base 12 is truncated-pyramid shaped as shown in the FIG. 2. The supporting base 13 has same shape as the mounting base 12. The mounting base 12 is inversely disposed on the top end 131 of the supporting base 13. The inclined lateral face 132 of the supporting base 13 intersects with the inclined lateral face 122 of the mounting base 12 at a polygon near a joint of the supporting base 13 and the mounting base 12. In the present disclosure, a light emitting angle of each LED unit 14 is defined as β. An angle a between the inclined lateral face 132 of the supporting base 13 and the inclined lateral face 122 of the mounting base 12 is in a range from β/2 to 90+β/2 degrees.

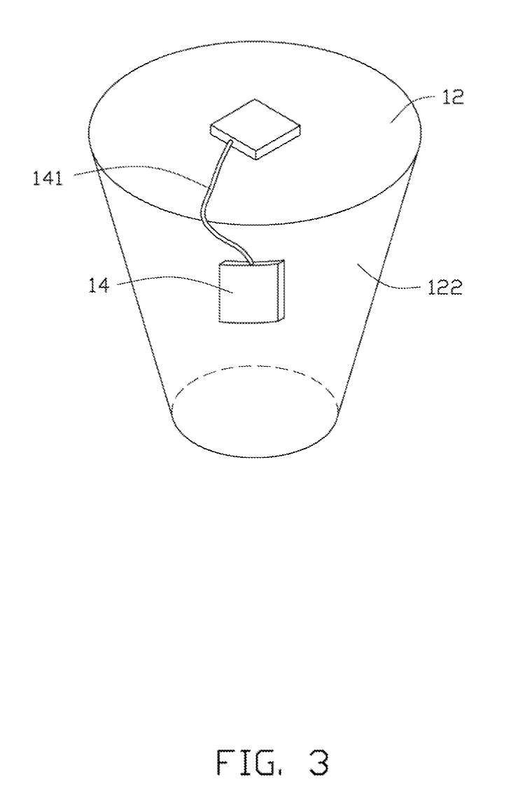

The mounting base 12 is truncated-cone shaped as shown in the FIG. 3. The supporting base 13 has a same shape as the mounting base 12. The mounting base 12 is inversely disposed on the top end 131 of the supporting base 13. The inclined lateral face 132 of the supporting base 13 intersects with the inclined lateral face 122 of the mounting base 12 at a circle near a joint of the supporting base 13 and the mounting base 12. An angle a between a tangent plane of the inclined lateral face 132 of the supporting base 13 and a tangent plane of the inclined lateral face 122 of the mounting base 12 is in a range from β/2 to 90+β/2 degrees.

The inclined lateral face 132 of the supporting base 13 is covered by a reflective layer 137 to reflect the light emitted from the LED unit 14 mounted on the inclined lateral face 122 of the mounting base 12 towards a periphery of the LED bulb 100.

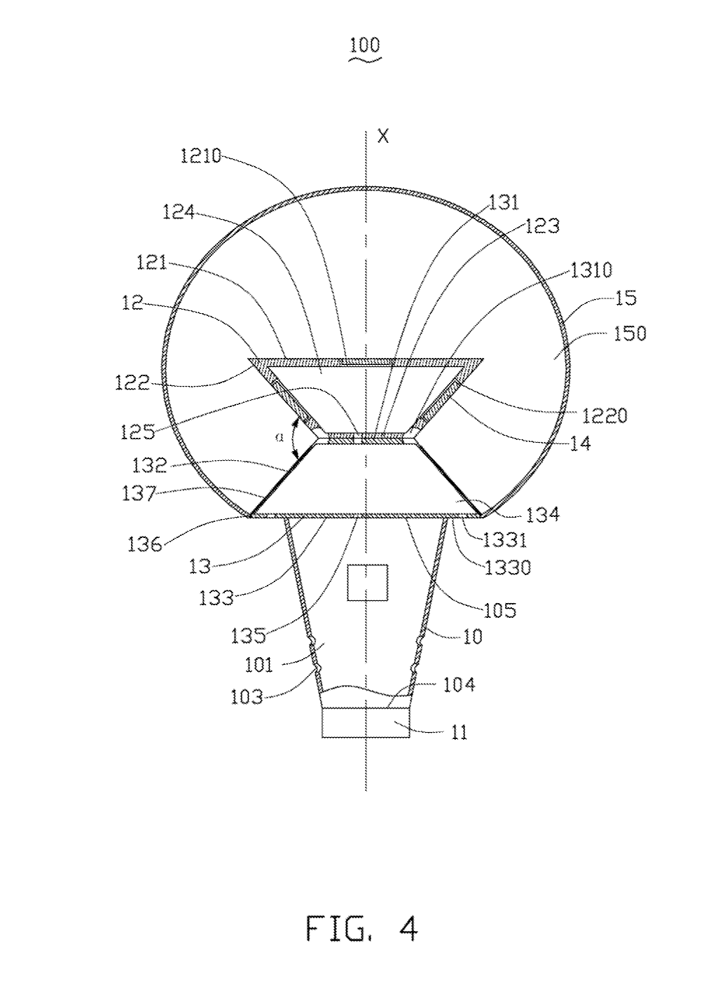

Referring to FIG. 4, different from the LED bulb 100 shown in FIG. 1, the bottom end 133 of the supporting base 13 has a size larger than that of the second end 105 of the connecting body 10. A plurality of air outlets 1331 are formed on an annular area 1330 of the bottom end 133 of the supporting base 13. The annular area 1330 of the bottom end 133 of the supporting base 13 is exposed out of the lampshade 15. The plurality of air outlets 1331 extend through the bottom end 133 of the supporting base 13 to communicate the second inner cavity 134 of the supporting base 13 with the outside.

The mounting base 12 defines a plurality of receiving recesses 1210, 1220 in the top face 121 and the inclined lateral face 122 thereof for receiving the LED units 14. Each of the receiving recess 1210, 1220 is rectangular shaped and each LED unit 14 is received in a corresponding receiving recess 1210 or corresponding receiving recess 1220. A light emitting surface of each LED unit 14 is coplanar with a corresponding top face 121 or corresponding inclined lateral face 122 of the mounting base 12.

In the present disclosure, the LED unit 14 mounted on the top face 121 of the mounting base 12 emits light in a direction different from directions of the light emitted from the LED units 14 that are mounted on the inclined lateral face 122 of the mounting base 12. Therefore, the LED units 14 emit light in all directions into space, thus the LED bulb 100 having a wide light distribution angle is obtained. The inclined lateral face 132 of the supporting base 13 reflects a portion of light rays emitted from the LED units 14 mounted on the inclined lateral face 122 of the mounting base 12 towards a periphery of the LED bulb 100 to improve the light intensity distribution of the LED bulb 100.

In the first embodiment, the second inner cavity 134 of the supporting base 13 communicates with the first inner cavity 124 of the mounting base 12 and the passage 101 of the connecting body 10. During operation, The LED units 14 generate a huge amount of heat and a portion of heat is transferred into ambient air enclosed in the lampshade 15 to increase air temperature enclosed in the lampshade 15 up to a high level. A portion of heat air enclosed in the lampshade 15 flows into the first inner cavity 124 of the mounting base 12 and the second inner cavity 134 of the supporting base 13 via air inlets 1310, flows through the passage 101 of the connecting body 10, and then flows out of the lamp bulb 100 via air outlets 103. Thus, the LED bulb 100 having a high heat dissipation efficiency is obtained.

In the second embodiment, the second inner cavity 134 of the supporting base 13 communicates with the first inner cavity 124 of the mounting base 12 and the passage 101 of the connecting body 10. During operation, The LED units 14 generate a huge amount of heat and a portion of heat is transferred into ambient air enclosed in the lampshade 15 to increase air temperature enclosed in the lampshade 15 up to a high level. A portion of heat air enclosed in the lampshade 15 flows into the first inner cavity 124 of the mounting base 12 and the second inner cavity 134 of the supporting base 13 via air inlets 1310, and then flows out of the lamp bulb 100 via air outlets 1330 of the supporting base 13. Thus, the LED bulb 100 having a high heat dissipation efficiency is obtained.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light emitting diode (LED) bulb comprising:
a connecting body having a first end and a second end opposite to the first end;
a mounting base located at the second end of the connecting body, the mounting base comprising a top face distant from the second end of the connecting body and an inclined lateral face located between the top face of the mounting base and the second end of the connecting body, and the inclined lateral face of the mounting base extending downwardly and inwardly from a periphery of the top face of the mounting base towards the second end of the connecting body; and
a plurality of LED units mounted on the first top face and the inclined lateral face of the mounting base, respectively.

2. The LED bulb of claim 1, further comprising a supporting base located between the mounting base and the second end of the connecting body, wherein the supporting base interconnects the mounting base and the second end of the connecting body.

3. The LED bulb of claim 2, wherein the supporting base comprises an inclined lateral face, and the inclined lateral face of the supporting base extends upwardly and inwardly from a periphery of the second end of the connecting body towards a bottom end of the mounting base.

4. The LED bulb of claim 3, wherein the supporting base interconnects end-to-end with the mounting base.

5. The LED bulb of claim 4, wherein the bottom end of the mounting base has a same size as that of the top end of the supporting base.

6. The LED bulb of claim 5, wherein the supporting base and the mounting base are truncated-cone shaped.

7. The LED bulb of claim 3, further comprising a reflective layer covering the inclined lateral face of the supporting base.

8. The LED bulb of claim 3, wherein the mounting base defines a plurality of receiving recesses in the top face and the inclined lateral face thereof for receiving the LED units therein.

9. The LED bulb of claim 8, wherein each receiving recess is rectangular and each LED unit is received in a corresponding receiving recess, and a light emitting surface of each LED unit is coplanar with a corresponding top face or inclined lateral face of the mounting base.

10. The LED bulb of claim 3, wherein the connecting body is a hollow tube and defines a passage to receive a driving circuit module therein.

11. The LED bulb of claim 10, wherein the mounting base comprises a first inner cavity, and the supporting base comprises a second inner cavity to communicate the first inner cavity of the mounting base with the passage of the connecting body.

12. The LED bulb of claim 11, further comprising a first through hole and a second through hole, wherein the first through hole extends through a bottom portion of the mounting base and a top portion of the supporting base to communicate the first inner cavity of the mounting base with the second inner cavity of the supporting base, and the second through hole extends through a bottom portion of the supporting base to communicate the second inner cavity of the supporting base with the passage of the connecting body.

13. The LED bulb of claim 11, wherein a low portion of the connecting body defines a plurality of air outlets therein, and the plurality of air outlets communicate the passage of the connecting body with the outside.

14. The LED bulb of claim 13, further comprising a lampshade connected to a bottom end of the supporting base, wherein the lampshade defines an inner space for receiving the supporting base and the mounting base therein.

15. The LED bulb of claim 14, wherein a plurality of air inlets are defined near a joint of the mounting base and the supporting base in the lampshade, and the plurality of air outlets communicate with the first inner cavity of the mounting base and the second inner cavity of the supporting base.

16. The LED bulb of claim 14, wherein the bottom end of the supporting base has a size larger than that of the second end of the connecting body.

17. The LED bulb of claim 16, wherein an area of the bottom end of the supporting base exposed out of the lampshade defines a plurality of air outlets, and the plurality of air outlets communicate the second inner cavity of the supporting base with the outside.

18. The LED bulb of claim 14, wherein a bottom end of the supporting base defines an annular groove near a joint of the supporting base and the second end of the connecting body, and the lampshade is fixed in the annular groove of the supporting base.

19. The LED bulb of claim 5, wherein the supporting base and the mounting base are truncated-pyramid shaped, and the inclined lateral face of the supporting base intersects with the inclined lateral face of the mounting base at a polygon.

20. The LED bulb of claim 19, wherein a light emitting angle of each LED unit is defined as β, and an angle a between the inclined lateral face of the supporting base and the inclined lateral face of the mounting base is in a range from β/2 to 90+β/2 degrees.
